(19) United States
(12) Patent Application Publication
(10) Pub. No.: US 2024/0218979 A1
(43) Pub. Date: Jul. 4, 2024

(54) Method for Adsorptive Storage of Natural Gas, Methane, and Complex for Implementation Thereof

(71) Applicant: PUBLICHNOE AKTSIONERNOE OBSCHESTVO GAZPROM, Saint-Petersburg (RU)

(72) Inventors: Anatolii Alekseevich FOMKIN, Moscow (RU); Andrei Viacheslavovich SHKOLIN, Khimki (RU); Ilia Evgenevich MENSHCHIKOV, Moscow (RU); Oleg Yevgenievich AKSIUTIN, Moscow (RU); Aleksandr Gavrilovich ISHKOV, Moscow (RU)

(73) Assignee: PUBLICHNOE AKTSIONERNOE OBSCHESTVO «GAZPROM», Saint-Petersburg (RU)

(21) Appl. No.: 18/288,499

(22) PCT Filed: Dec. 27, 2021
(86) PCT No.: PCT/RU2021/000597

§ 371 Date: Oct. 26, 2023

(30) Foreign Application Priority Data
Oct. 4, 2021 (RU) 2021128853

(51) Int. Cl. F17C 11/00; C10L 3/10; F17C 5/06

(52) U.S. Cl. CPC F17C 11/007; C10L 3/101; F17C 5/06; F17C 2201/0109; F17C 2201/032; F17C 2203/012; F17C 2203/0604; F17C 2203/0678; F17C 2221/033; F17C 2225/035; F17C 2225/036; F17C 2260/042; F17C 2270/0134

(57) ABSTRACT

This group of inventions relates to gas industry, in particular, to land storage of natural gas, and it may be used for storage, distribution and supply of natural gas, methane or associated petroleum gas, regardless of geological and geographic characteristics of the complex location. Complex of strategic land storage provides for energy efficient and safe storage, distribution and supply of natural gas, methane and/or associated petroleum gas in the adsorbed condition within a wide range of temperatures and pressures. Method for adsorptive storage of natural gas, methane in the complex for land adsorptive storage of natural gas includes offtake of natural gas from a gas source, its treatment including purification from solid inclusions and foreign admixtures, and treatment of microporous adsorbent in the high-pressure tank of the land gas adsorptive storage module, further filling of the gas storage unit with purified gas directly from the gas source through the natural gas treatment unit until the gas source pressure is achieved, and then, through the natural gas compression unit, until the gas storage pressure of 3-10 MPa is achieved.

This group of inventions relates to gas industry, in particular, to land storage of natural gas, and it may be used for storage, distribution and supply of natural gas, methane or associated petroleum gas, regardless of geological and geographic characteristics of the complex location.

A method for storage of compressed natural gas in a subsurface cavity washed out with water in mineral salt and under pressure usually exceeding 100 kg/cm² is known (V. A. Mazurov, Subsurface Storage Facilities in Mineral Salt, Moscow, Nedra, 1982). A cavity with volume exceeding 10,000 m³ washed out at the depth of at least 600 m is required to store 1 mln m³ of natural gas. Construction of such storage facilities is extremely restricted geologically/geographically and geophysically, and is possible only at mineral salt deposits. Moreover, its construction requires considerable expenditures and time.

A method for storage of natural gas (NG) in liquefied state is known, for example, [GOST R 56352-2015 Petroleum and Natural gas Industries. Production, Storage and Handling of Liquefied Natural Gas]. Liquefied natural gas (LNG) is a mixture of light hydrocarbons, nitrogen and carbon dioxide admixtures included in NG, with predominant content of methane technologically liquefied by deep cooling down to cryogenic temperatures (approximately minus 162° C.) (thermodynamic conditions under which a gas becomes liquid at near-atmospheric pressure). Liquefaction of methane NG is carried out using special cryogenic plants operating on the principle of throttle, expansion cycles, cascade, cooling and combined cycles. Due to technological liquefaction of natural gas its density increases abruptly 500-600 times exceeding the density of a gaseous substance under normal conditions. Thus, an opportunity for effective storage and transportation of extra large amounts of NG is provided.

Storage of natural gas in the liquefied condition is usually carried out using tanks consisting of an inner shell made of 12Cr18Ni10Ti corrosion-resistant steel, thermal insulation made on the basis of the technology conventional for cryogenics (powder insulation), and outer shell made of cast-in-situ reinforced concrete (I. P. Usyukin, Cryoengineering Plants, Machines and Devices.—Moscow: Consumer Goods and Food Industry, 1982, p. 275).

The disadvantage of this storage method is high fire and explosion hazard due to stratification phenomena, or density foliation of liquid natural gas, which results in rollover (abrupt increase in gas cushion pressure above the face of LNG), as well as high cost of gas storage connected with necessity of cooling thereof down to cryogenic temperatures, deliquefying during storage and heating to make it usable.

Also, methods of natural gas storage in the condition bound with an external structure, for example, in gas hydrates (patent of the Russian Federation No. 2293907 publ. on 20. Feb. 2007, IPC F17C 11/00). When storing natural gas in tanks in the form of hydrates, a surfactant aqueous solution held at pressure exceeding the balanced pressure by 20-30% is used as a hydrate-forming aqueous medium to form pure methane hydrate at pre-determined temperature.

Storage is carried out using a storage tank represented by a steel vessel rated for pressure of 2 MPa. There is a coil installed inside the vessel at its bottom part through which coolant is pumped for heating or cooling of the tank contents.

Such storage method has a number of disadvantages related to low energy efficiency of the storage system that is dictated by necessity to continuously maintain low temperatures in the process of storage by pumping-through a coolant, and necessity to use special-purpose high-efficiency gas drying systems prior to delivery thereof to the consumer, as well as low specific capacity of the gas storage. The closest analogous solution is the method for natural gas storage in the compressed condition using high-pressure gas holders, for example, [U. S. Karabalin, F. A. Mamonov, K. M. Kabyldin, M. M. Yermekov, Transportation and Storage of Oil, Gas and Oil Products.—Almaty: TST-Company, 2005. —509 pages].

Constant capacity (high-pressure) gas holders act as gas accumulators at gas supply stations for settlements, metallurgical or chemical enterprises. Pressure in such tanks may be up to 2 MPa. Structurally, high-pressure gas holders are metal welded or cast, cylindrical or spherical tanks with different volume. However, increase in volume of gas stored is usually provided by application of several tanks united in one gas system. Gas holder stations are engineering structures consisting of a large number of gas holders or batteries thereof that are designed to cover peak gas demand at settlements or industrial enterprises. Gas is supplied to gas holder stations from the MDS (main distribution station) through high-pressure transit mains. Then, gas from gas holders is fed to medium-pressure networks that are circular and interrelated which allows for reservation of the gas holder stations' capacities. Control substations are constructed at some points of the medium-pressure networks through which the supply to low-pressure networks is carried out.

Disadvantages of such storage method are low specific capacity for natural gas storage of up to 20 m³ (gas)/m³ (storage system), as well as elevated fire and explosion hazard when high-pressure gas holders are used.

The problem to be solved by the provided group of inventions is represented by development of a simple, robust and efficient method for land adsorptive storage of natural gas, methane, and complex for implementation thereof.

Technical result to be achieved by the group of inventions is represented by simplicity of implementation, safety and energy efficiency of land adsorptive storage of natural gas, methane while keeping the quality of natural gas and its calorie content, as well as covering the natural gas demand of different consumers under conditions of sharp non-uniformity of consumption, regardless of geological and geographical characteristics of the complex location.

Additional technical result is considered to be the reduction of specific quantity of metal in the gas storage module, as well as an opportunity to implement energy-saving gas filling-in and extraction procedures staged by pressure.

An additional technical result is the improvement of feasibility and simplicity of complex manufacturing, essential reduction of the adsorptive storage complex manufacture period, and reduction of natural gas storage costs.

Said technical result is achieved by the fact that the complex for land adsorptive storage of natural gas, methane according to the first embodiment comprises a gas treatment unit, gas compression unit and gas storage unit having constant pressure that are successively arranged, the gas storage unit comprising one or several land gas adsorptive storage modules each of which is a high-pressure vertical cylindrical gas tank designed in the form of a set of concentrically arranged cylindrical shells with different diameter placed one inside another and having an annular gap therebetween filled with a microporous adsorbent to the extent not exceeding 97% of its volume, and said adsorbent accumulates at least 155 nm³ of natural gas per 1 m³ of adsorbent; however, the thicknesses of all shells are equal, and gas storage pressure in the tank increases from the periphery towards the center.

Said technical result is achieved by the fact that the complex for land adsorptive storage of natural gas, methane according to the second embodiment comprises a gas treatment unit, gas compression unit and gas storage unit having constant pressure that are successively arranged, the gas storage unit comprising one or several land gas adsorptive storage modules each of which is a high-pressure tank the bearing wall of which is made of cast-in-situ reinforced concrete reinforced with pre-stressed rods, or has a combined design of a series of layers made of metal and cast-in-situ reinforced concrete reinforced with pre-stressed rods; however, the inner surface of the tank is lined using a gas-barrier material, and the tank is filled with a microporous adsorbent to the extent not exceeding 97% of its internal volume, and said adsorbent accumulates at least 155 nm³ of natural gas per 1 m³ of adsorbent.

Said technical result is achieved by the fact that the complex for land adsorptive storage of natural gas, methane according to the third embodiment comprises a gas treatment unit, gas compression unit and gas storage unit having constant pressure that are successively arranged, the gas storage unit comprising one or several land gas adsorptive storage modules each of which is a high-pressure tank designed in the form of vertically arranged large-diameter metal gas pipes having the operating pressure of at least 3 MPa; however, upper and lower crowns of pipes are closed with spherical covers, and the lower parts of the pipes are closed liners for fixation of the main part cast into cast-in-situ concrete, and the tank is filled with microporous adsorbent to the extent not exceeding 97% of its internal volume, and said adsorbent accumulates at least 155 nm³ of natural gas per 1 m³ of adsorbent.

However, microporous adsorbent may be granulated or compacted in the form of blocks.

Gas treatment unit additionally includes the sections for purification from solid inclusions and foreign admixtures, section of natural gas flow enrichment with methane and C2+ hydrocarbon storage section; gas storage unit additionally includes C2+ capturing and storage module the inner volume of which is filled with adsorbent having the ethane/methane separation coefficient of at least 2 and installed in front of the land gas adsorptive storage module, compensation tank to release pressure exceeding the operating pressure of the high-pressure tank, as well as the regeneration section of the land gas adsorptive storage module connected with the high-pressure tank and C2+ hydrocarbon capturing and storage module.

Adsorbent of the C2+ hydrocarbon capturing and storage module may be granulated or compacted in the form of blocks.

Modules of the land gas adsorptive storage are mounted in such a way that each of them may be individually disconnected from the gas source.

Said technical result is achieved due to the fact that the method for land adsorptive storage of natural gas, methane includes offtake of natural gas from a gas source, treatment of microporous adsorbent accumulating at least 155 nm³ of natural gas per 1 m³ of adsorbent in the high-pressure tank of the land gas adsorptive storage module of the gas storage unit, further filling of the gas storage unit with gas directly from the gas source until the gas storage pressure of 3-10 MPa is achieved; or offtake of natural gas from a gas source, its treatment in the natural gas treatment unit that includes purification from solid inclusions and foreign admixtures, treatment of microporous adsorbent accumulating at least 155 nm³ of natural gas per 1 m³ of adsorbent in the high-pressure tank of the land gas adsorptive storage module of the gas storage unit, further filling of the gas storage unit with purified gas until the gas storage pressure of 3-10 MPa or the gas source pressure is achieved, and then, through the natural gas compression unit, until the gas storage pressure of 3-10 MPa is achieved.

Additionally, natural gas treatment includes natural gas separation using a cryogenic, adsorptive or membrane method or the combination thereof into methane-enriched natural gas and C2+ hydrocarbon concentrate. Treatment of microporous adsorbent in the granulated form or compacted in the form of blocks in high-pressure tanks is carried out by purging with heated nitrogen with excess pressure of up to 0.05 MPa, vacuuming until rarefaction of not more than 104 MPa is achieved and further purging with purified and methane-enriched natural gas at excess pressure of 0.05-0.15 MPa. In the gas storage unit, purified gas is fed to the C2+ hydrocarbon capturing and storage module the inner volume of which is filled with adsorbent having the ethane/methane separation coefficient of at least 2, and then the methane-enriched gas is delivered for storage to the land gas adsorptive storage module. Purified gas is fed to the C2+ hydrocarbon capturing and storage module the inner volume of which is filled with adsorbent in the granulated form or compacted in the form of blocks.

Essence of the group of inventions is explained by detailed description of particular exemplary embodiments and accompanying drawings that, however, do not limit the present group of inventions.

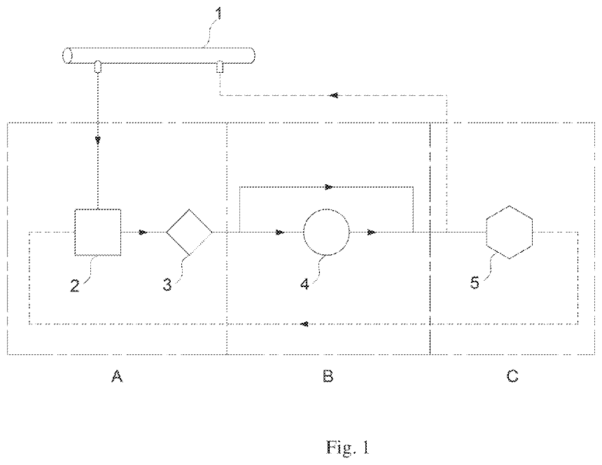

FIG. 1 shows the general diagram of the complex for land adsorptive storage of natural gas, methane;

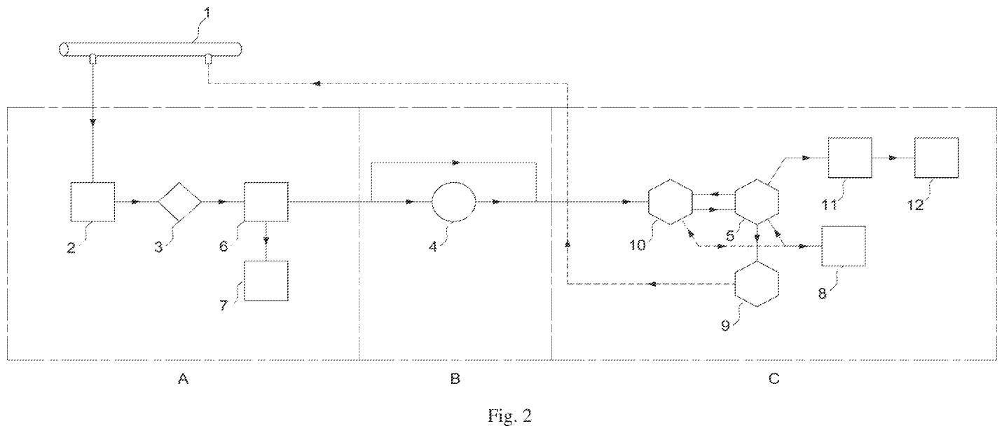

FIG. 2—diagram of the complex for land adsorptive storage of natural gas, methane;

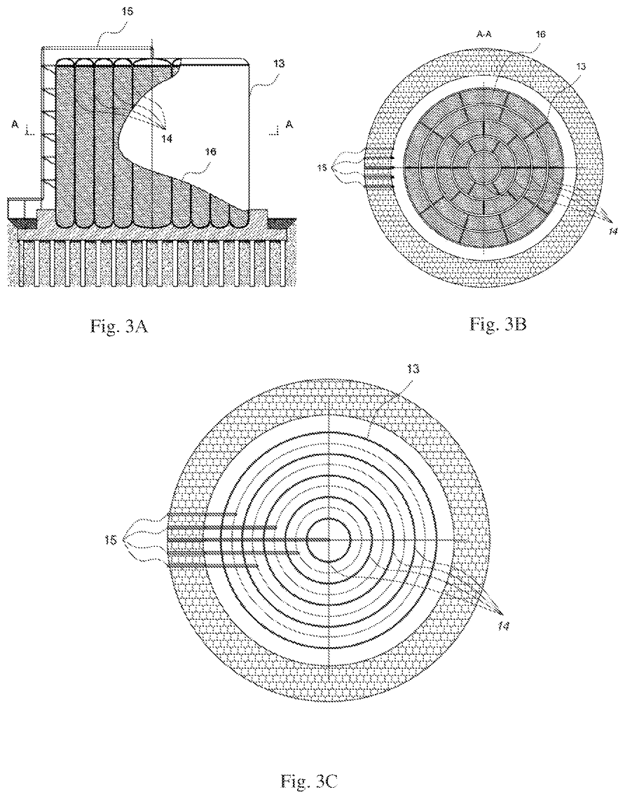

FIG. 3—concentric adsorptive pressure vessel with equal shell wall thickness of the complex for land adsorptive storage of natural gas, methane according to the first embodiment where: a is the front view of the module, b is cut-off (A-A), and c is the top view (C);

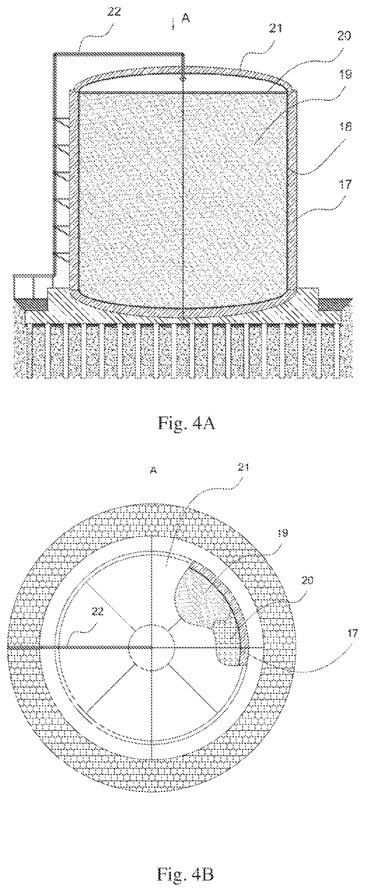

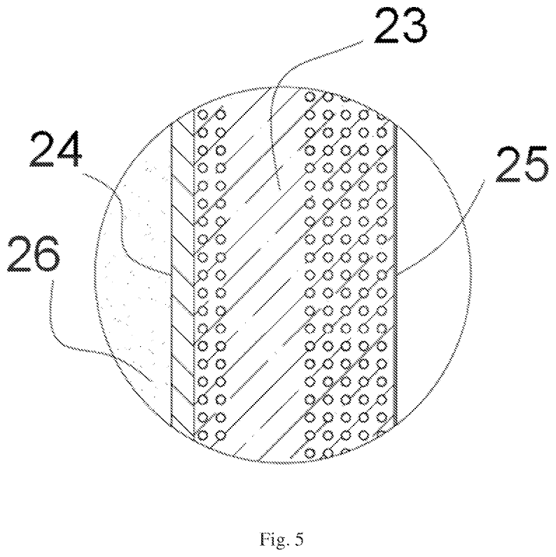

FIG. 4—the tank of the natural gas, methane adsorptive storage module with combined wall made of cast-in-situ reinforced concrete and metal sheets of the complex for land adsorptive storage of natural gas, methane according to the second embodiment where: a is the front view of the module, b is the top view;

FIG. 5—design of the combined wall made of cast-in-situ reinforced concrete and metal sheets of the natural gas, methane adsorptive storage module:

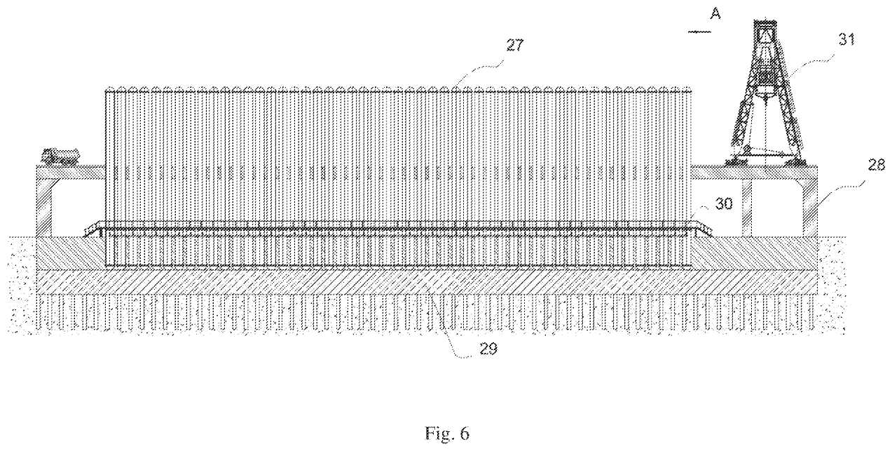

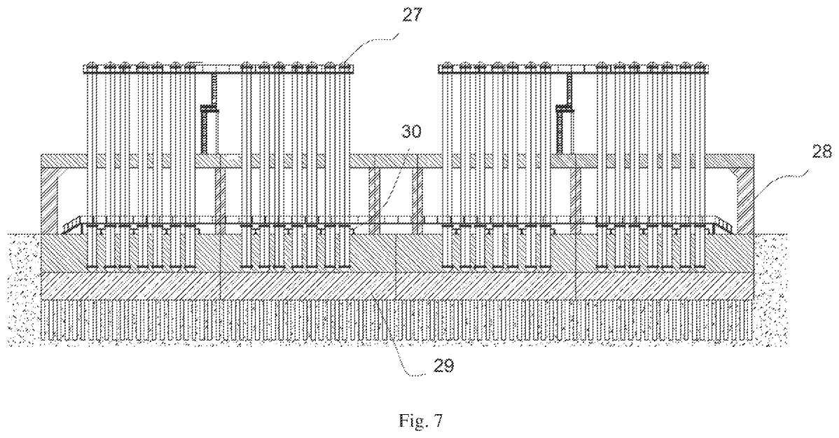

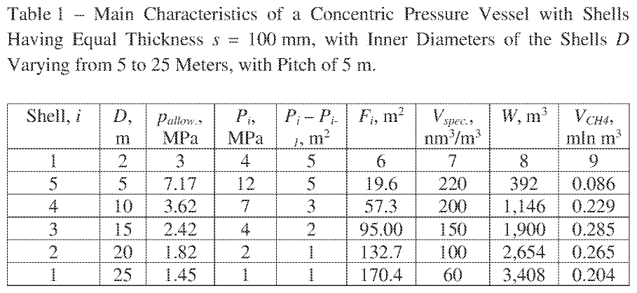

FIG. 6-7—natural gas adsorptive storage module made of large-diameter (1,420 mm) main gas pipes: a—front view; b—view (A) of the complex for land adsorptive storage of natural gas, methane according to the third embodiment.

Complex for land adsorptive storage of natural gas, methane (embodiments) comprises:
A—natural gas treatment unit;
B—natural gas compression unit;
C—gas storage unit.
1—natural gas source;
2—section for purification from solid inclusions;
3—section for purification from foreign admixtures;
4—compressor equipment;
5—gas (natural gas, methane) land adsorptive storage module (modules) connected with section 2 for purification from solid inclusions and natural gas source 1;
6—section for natural gas flow enrichment with methane;
7—C2+ hydrocarbon storage section;
8—regeneration section of high-pressure tanks of land gas adsorptive storage module (modules);
9—additional tanks connected with natural gas source 1 and land gas adsorptive storage module (modules) 5;
10—C2+ hydrocarbon capturing and storage module connected with regeneration section 8 of high-pressure tanks of land gas adsorptive storage module (modules) 5;
11—compressor equipment;
12—methane-enriched natural gas consumer.
13—external steel shell;
14—internal steel shell;
15—gas supply pipelines;
16—adsorptive material filler;
17—cast-in-situ reinforced concrete tank;
18—internal steel shell;
19—adsorptive material filler;
20—protective plate;
21—cover;
22—gas supply pipelines;
23—reinforced concrete wall;
24—internal steel shell;
25—metal protection;
26—adsorbent;
27—vertical adsorptive pipe columns;
28—module bearing wall;
29—module foundation plate;
30—gas supply pipelines;
31—crane for servicing of adsorptive pipe columns.

In general, the method for natural gas storage provided is represented by storage of gas in the adsorbed form. Use of the method for adsorptive storage of natural gas allows for improvement of energy efficiency and safety of natural gas storage.

Use of adsorbent in the high-pressure tank makes it possible to reduce the fill pressure more than two-fold having the same volume of natural gas in comparison with a tank without adsorbent. Additionally, relative efficiency of adsorptive accumulation (ratio of the amount of gas stored in the storage system with an adsorbent and without it) increases as the pressure reduces, and this allows for energy efficient compression of natural gas by means of power cost reduction and use of simpler compression equipment that is cheap to maintain. Moreover, natural gas storage unit may be filled through the main gas pipelines directly using a compressionless method, or with minimum compression.

Furthermore, it is known that the adsorbate (natural gas in this case) in a microporous adsorbent remains in nanodispersed condition within the adsorption force field which prevents gas from abrupt discharge in case the tank is depressurized, i.e. it prevents the possibility of achieving the conditions for gas explosion and makes the method disclosed safer.

Another advantage of this method for natural gas storage in comparison, for example, with storage in a subsurface gas or gas-hydrate storage facilities is preservation of gas quality and calorie content which is very important, for instance, in case of use of the storage method disclosed, for compensation of irregularities of export gas supplies or use of gas as a gas-engine fuel.

Complexes for land storage of natural gas (hereinafter referred to as the Complex) based on the method provided may be quite widespread, and possibility of modular principle of storage scaling or the amount of gas stored makes it possible to locate such complexes both at the territories of plants (for industrial gas fuel supply) and near villages, settlements, rural communities, cities and other residential areas to cover their natural gas demands with due account for their development dynamics. Complexes may be located in climatic zones with average annual temperatures from minus 40 to plus 30° C. It should be noted that the amount of natural gas stored in the adsorbed form will increase even at lower temperatures up to the methane liquefaction one, and thus the Complexes claimed may be operated at temperatures below minus 40° C. provided that functioning of all of their units is assured in general.

Generally, the working principle of a Complex implementing the method is as follows. Gas from source 1 is fed to natural gas treatment unit A where it is treated at the section for purification from solid inclusions 2 and section for purification from foreign admixtures 3, such as moisture, sulfur oxides, carbon dioxide, etc. Upon purification, the gas is delivered to compression unit B and then to gas storage unit C. In case of filling using a main gas pipeline where the gas is under elevated pressure, filling of adsorptive storage modules 5 is carried out directly, without application of compressor equipment 4 of compression unit B. In case the operating pressure of gas source 1 is below the operating pressure of adsorptive storage modules 5, filling of adsorptive storage modules 5 up to the gas source 1 operating pressure is carried out without compressor equipment 4, and then—with it. In case the composition of natural gas from source 1 meets the requirements to gas composition specified by the conditions of the Complex operation, adsorptive storage modules 5 may be filled directly, by-passing the natural gas treatment unit. Gas supply from adsorptive storage modules 5 is performed through the solid inclusion purification filter of section 2 of natural gas treatment unit A directly back to natural gas source 1 or, if necessary, through compressor equipment 4 of natural gas compression unit B.

Adsorptive storage module 5 of gas storage unit C is a high-pressure tank or several high-pressure tanks united in a gas network in such a way that each of them could be individually disconnected from the gas network. This would enable increasing the storage feasibility, since in case of an accident, repair or scheduled maintenance of the high-pressure tank, shutdown of entire storage facility is not required, and disconnection of a single tank will be enough. Besides, such approach may prove to be more versatile and economically feasible for a gas consumer. Gas storage capacity may be set in strict accordance with the requirements and intended use of the Complex, with unimpeded possibility to increase or reduce the capacities. Also, gradual commissioning of a storage is possible depending on the progress of construction works (module after module). Apparently, the number of modules may vary within a wide range, and the upper limit may be dictated by territorial and economic reasons only. It is important to note that the modular principle allows for unification of the storage facilities and making them typical, at least within the framework of an individual Complex, which will result in significant reduction of costs for development of new design solutions and implementation of construction and installation works.

Each of high-pressure tanks 5 is made in the form of a sealed vessel capable of withstanding elevated pressure, in particular, 3 to 10 MPa. This range of operating pressures corresponds with the pressure values in the storage system for which the most efficient operation of adsorptive systems is observed. It is within this pressure range that the biggest difference between the densities of adsorbed natural gas and compressed gas is observed.

High-pressure tank 5 is equipped with microporous adsorbent for natural gas storage and, preferably, its main component—methane. Microporous adsorbent used in high-pressure tanks of the type represented by microporous carbon adsorbent, activated carbon, metalloorganic frame structure, sol-gel, metalloorganic gel, composite microporous material or mixtures thereof shall be capable of outputting at least 155 nm³ (natural gas)/m³ (adsorbent) to a consumer. Adsorbent shall be in the form of granules, grains or blocks of different form, for example, tablets, cylinders, hexagonal prisms, rectangular blocks, square blocks, tori, etc., for reduction of dusting and adsorbent discharge from the high-pressure tank to the gas network. However, high-pressure tanks shall be filled with adsorbent to the extent not exceeding 97% of the tank internal volume. It is necessary, since adsorptive and thermal deformation of adsorbent related to heating up occurs in the process of adsorption. The extent of expansion deformation for the overwhelming majority of adsorbents during adsorption of methane and normal hydrocarbons is not higher than that of C5+(main components of natural gas) and does not exceed 1% in linear measurement, or 3% by volume. Therefore, a space for adsorbent expansion shall remain in the tank to reduce the probability of mechanical damage to the tank due to additional uncompensated loads on the walls, as well as adsorbent destruction which may result in elevated dusting and, as a consequence, to elevated discharge of dust to the gas transportation network of the Complex.

In particular cases, natural gas is enriched with methane to increase the efficiency of its storage. In case of accumulation of methane-enriched natural gas in an adsorbent, heavy hydrocarbons will be accumulated in significantly less quantities and, therefore, the adsorption capacity of the adsorbent will be reduced. This may provide for increase in the number of operation cycles (adsorption/desorption) of the tanks of the natural gas adsorptive storage module due to the increased interval between adsorbent regeneration in the tanks.

For embodiment of this method, in addition to the method described before, methane enrichment section 6 is added to natural gas treatment unit A where capturing of C2+ hydrocarbons and transportation thereof to C2+ hydrocarbon storage section 7 (FIG. 2) is carried out using the cryogenic, adsorptive or membrane methods, or a combination thereof, from where extracted C2+ gases concentrated in an individual vessel are transported for processing, to the consumer or are returned to the gas source. As necessary, gas flows at the methane enrichment section 6 input and output are to undergo periodic composition analysis to verify the quality of gas and, accordingly, to check whether functioning of equipment at the section meets set requirements.

High feasibility and maintainability of adsorptive storages are determined, among other things, by the possibility to restore initial adsorptive properties of a microporous adsorbent inside high-pressure tanks of the gas adsorptive storage module without unloading and replacement; FIG. 2.

Initial preparation of natural gas adsorptive storage module (modules) including its periodic regeneration during use is carried out in gas storage unit C of regeneration section 8. Systems of the regeneration section are connected to the module tanks under service to restore the adsorptive properties of the adsorbent: tanks are purged with heated nitrogen under excess pressure of up to 0.05 MPa. To improve adsorbent treatment, additional vacuuming of high-pressure tanks up to rarefaction not exceeding 1 mbar is acceptable. After that, the high-pressure tanks are purged with purified and methane-enriched natural gas under excess pressure of 0.05 . . . 0.15 MPa.

Purge pressure of a treated tank using natural gas is selected based on the data on commissioning periods of said reservoir for gas adsorptive storage module and on expected temperature variations for the period of time between the completion of the tank treatment and its commissioning. The main criterion is keeping excess pressure in the tank in case of temperature drop, for example, at night or during seasonal changes.

Additionally, gas adsorptive storage module has additional tanks 9 under excess pressure that is lower than the pressure in high-pressure tanks 5; FIG. 2. Tanks 9 are designed to relieve pressure exceeding the operating one from high-pressure tanks 5 of gas adsorptive storage module 5. Tanks 9 may have operating pressure less or equal to the operating pressure of high-pressure tanks, and they can be both equipped with microporous adsorbent capable of providing the output of 155 nm³ (natural gas)/m³ (adsorbent) for the consumer and not equipped with it. Natural gas supply from additional tanks 9 may be provided both for auxiliaries of the Complex and to the gas source (consumer) when the natural gas compression unit is used.

Improvement of the operation efficiency of the gas adsorptive storage module (modules) by means of filling the high-pressure tanks with methane-enriched natural gas may be carried out when a dual-module storage is used, the first module 10 of which is fitted with adsorbent (for example, of the type represented by microporous carbon adsorbent, activated carbon, metalloorganic frame structure, sol-gel, metalloorganic gel, composite microporous material or mixtures thereof) having ethane/methane separation coefficient of at least 2, in the granulated form or compacted in the form of blocks for accumulation of C2+ hydrocarbons; and the second module 5 of which is fitted with microporous adsorbent in the granulated form or compacted in the form of blocks that is capable of outputting at least 155 nm³ (natural gas)/m³ (adsorbent) to the consumer, and said second module has larger total capacity of gas stored than the first one. Methane content in natural gas to be injected in the storage shall serve as the criterion for assessment of the ratio between two modules.

Operation of gas storage in such design (FIG. 2) implies that natural gas passing through the first storage module 10 is separated, and the natural gas components higher than C2+ are completely or partially captured and concentrated in the adsorbent in the high-pressure tanks of the first natural gas adsorptive storage module, and methane-enriched gas is transported to the second gas storage module 5 for storage. Additionally, C2+ hydrocarbons may be extracted to a separate vessel for concentration and transfer for processing or to a consumer. Or, in case of gas offtake from a storage, methane-enriched natural gas from the second module 5 is desorbed from module 1 by backflow, C2+ hydrocarbons concentrated during filling and natural gas having a composition similar to the initial one are fed to source 1.

In individual cases, for example, to fill and operate motor vehicles using natural gas motor fuel (methane) or mobile adsorption terminals for gas supply for sources remote from main gas pipelines, filling of methane-enriched natural gas is required. This may also become necessary during filling of the natural gas adsorptive storage modules. To do so, gas storage unit is equipped with compressor equipment 11 to fill consumers 12 (FIG. 2) when natural gas treatment and compression units cannot be used for this.

To implement the claimed method for natural gas storage, an entire process system needs to be established the central part of which would be the land gas adsorptive storage module (modules).

Main and the most essential structures of the Complex are specifically high-pressure tanks fitted with adsorbent of the natural gas adsorptive storage module characteristics of which shall ensure high values of the storage capacity, as well as gas dynamic behavior of offtake and filling of natural gas. Moreover, the tanks shall be robust, safe and maintainable. Land natural gas storage complex is related to the class of systems with high upper limit of operating pressure that may vary within wide intervals, in particular, from 3 to 10 MPa. During complex design, thermodynamic features of adsorption and desorption processes facilitating storage temperature variation during gas filling and extraction within the interval of minus 40 to plus 60° C. shall be additionally taken into account.

To embody the method for natural gas storage claimed, a complex for land storage of natural gas is provided comprising natural gas treatment, compression and storage units, the natural gas storage unit comprises high-pressure tank (s) of the gas adsorptive storage module (s) designed in the form of a set of concentrically arranged cylindrical shells 13, 14 with different diameters placed one inside another and having an annular gap therebetween filled with microporous adsorbent 16 to the extent not exceeding 97% of its volume, and said adsorbent outputs at least 155 nm³ (natural gas) per 1 m³ (adsorbent) to a consumer; however, the thicknesses of all shells are equal, and gas storage pressure in the tank increases from the periphery towards the center.

The aspect of the design claimed is that it consists of a set of concentrically arranged cylindrical shells having an annular gap therebetween that serves as a vessel for filling with gas through gas supply pipelines 15; FIG. 3. Such implementation scheme for the high-pressure tank allows for making a structure with equal thickness for all shells, but with different excess pressure values inside the vessels, and formed by radial gaps between the shells the value of which increases from periphery to the center. In this embodiment, the shell walls will function as membranes loaded with pressure both from the inside and outside, and inner pressure pᵢ is higher than the outer pressure pₒ, and resulting pressure Pᵣₑₛ is equal to the difference pᵢ−pₒ. Therefore, this solution allows for optimization of the wall thickness towards the lesser value and additional reduction of specific metal quantity. In order to improve the spatial rigidity of the structure, fitting it with radial stiffeners is feasible; FIG. 3 b.

Filling of such high-pressure tank is carried out as follows: first, a high-pressure tank is filled completely until the operating pressure of the external concentric vessel is achieved, and then gas feeding to the external concentric vessel is stopped, and gas is fed to the remaining vessels until the operating pressure of the next concentric vessel following the previous one is achieved, and the process is repeated until central vessel is filled up to the maximum operating pressure. Gas output is carried out in the reverse order starting from output from the central vessel with gradual engagement of the remaining concentric vessels from the center to the edge, and with appropriate natural gas output pressure values.

As an example of implementation of the structure claimed, the results of calculation of the main characteristics of a concentric pressure vessel with shells having equal thickness s=100 mm are provided, with inner diameters of the shells D varying from 5 to 25 meters, with pitch of 5 m; FIG. 3, Table 1. In this example, pressure in the tank is increased from 1 to 12 MPa.

Field 1 provides the numbers of shells “from the periphery to the center”, field 2 provides diameters, field 3 provides allowable internal excess pressure acting on each shell p_{allow.}, and field 4 provides assumed values of the internal excess pressure inside each of the shells Pᵢ. The results of verification of the condition of loadability using internal excess pressure Pᵢ are given in field 5, and inequation p_{allow.}≥Pᵢ−Pᵢ₋ₗ shall be solved. Fields 6 and 7 contain calculated areas of bases of the gaps between the shells and specific value of accumulating capacity of an adsorbent layer for the pressure levels specified.

Total “free” area of bases of the gaps between the shells is 475 m² which is just 15 m² less than the area of the base of a single tank with diameter of 25 m. It is important to note that thicknesses of the concentric tank shells are 100 mm, while wall thickness of a single tank D=25 m at 3 MPa shall already be 207 mm. Geometric volume W of such storage with height of 20 m is 9,501 m³, and usable storage capacity V_{CH4} for gas corresponds with assumed V_{spec.}-1.1 mln m³.

Shells in the solution claimed are loaded from both sides which makes possible optimization of their wall thicknesses. Different operating pressure values between the shells allow for step-by-step filling of the land gas adsorptive storage module. Thus, the solution claimed provides for implementation of an energy-saving filling staged by pressure and further extraction of natural gas, methane.

Another embodiment of the invention claimed is a complex for strategic land storage of natural gas comprising natural gas injection sections, purification from solid inclusions, purification from foreign admixtures, compression, storage in sealed vessels in the adsorbed form under constant pressure of gas injected in the storage for a set period of time and further offtake of natural gas; however, the natural gas adsorptive storage module is designed as a pressure vessel 17 the bearing wall of which is made of cast-in-situ reinforced concrete reinforced with pre-stressed rods, or has a combined design of a series of layers made of metal and cast-in-situ reinforced concrete reinforced with pre-stressed rods; additionally, the inner surface of the structure is lined using a gas-barrier material, and the tank is filled with an effective adsorbent to accumulate natural gas in the amount not exceeding 97% of its internal volume.

Reinforced concrete modules may be manufactured both at a reinforced concrete plant and in-situ. This allows for avoiding the problems associated with transportation of large capacity workpieces and items specific to metal tanks for gas storage.

Use of pre-stressed reinforced concrete in comparison with reinforced concrete without pre-stressing allows for significant reduction of bending and provision of improved crack resistance while having equal strength. Reinforcement rods made of steel with high tensile strength are laid during reinforced concrete making, and then this steel is tensioned using a special device, and concrete mix is cast. Upon curing, pre-stressing force of released steel wire or a rope is transferred to surrounding concrete, so that it becomes compressed. Such generation of compression stress allows for partial or complete elimination of tensile stressing caused by operational load.

To ensure tightness of the reinforced concrete adsorptive natural gas storage module, making a lining of the inner surface with a gas-barrier material, for example, metal sheets is feasible, with further ultrasonic examination of welded joints, or a special gas-barrier membrane could be installed. Simultaneous use of reinforced concrete in the tank walls and thick metal sheets transforms the structure into a combined one, when both layers (of reinforced concrete and metal) bear the load. Natural gas adsorptive storage module is provided as an example. Its tank is a reinforced concrete structure with internal metal liner made of metal sheets having a nominal volume of 9,420 m³ (tank with height of approximately 30 m and inner diameter of 23 m) that works under elevated pressure of up to 4 MPa; FIG. 4. Thickness of the tank reinforced concrete wall is 1 m. Tank walls comprise 105 reinforcement rods per each 1.5 m² of the module wall section in the plane perpendicular to the annular position of the rods. Example of the combined wall structure made of cast-in-situ reinforced concrete and metal sheets of the natural gas adsorptive storage module is given in FIG. 5. Tank 17 consists of internal steel shell 18, protective plate 20, cover 21 and is filled with a filler of adsorptive material 19 and 26.

The tank is filled with effective adsorbent to the extent not exceeding 97% of its internal volume that is capable of accumulating at least 150 nm³/m³ at the tank operating pressure. Natural gas volume such tank is capable to store is 1.41 mln m³.

FIG. 5 shows the module combined wall 23 structure comprising an internal steel shell 24, cast-in-situ wall with pre-stressed reinforcement rods and metal protective casing 25. Structural thickness of the module wall designed for 3.5 MPa will be over one meter.

Small dimensions of the tank with a combined wall made of cast-in-situ reinforced concrete and metal sheets allow for making a compact module for adsorptive storage of natural gas. Thus, an area of 2-3 ha may accommodate a strategic complex for land storage of natural gas the adsorptive natural gas storage module of which comprises from 9 to 12 tanks, and total amount of gas stored therein will be 12 to 16.5 ml nm³ of gas.

In case such structure is selected, the number of gas supply utility lines may be optimized, the cost of the storage may be significantly reduced, and its reliability may be improved.

In less detail, the following stages and sequence of construction and installation works for erection of a land adsorptive storage module made of reinforced concrete and having a combined wall may be determined: area planning; excavation of pit for foundation intended for arrangement of the natural gas adsorptive storage module; construction of pile field (if necessary); construction of the first layer of monolithic grillage (foundation slab); head installation with projection of the reinforcement frame for casting of cast-in-situ walls; installation of the second layer of monolithic grillage; installation of the central steel shell; installation of cover; backfilling of pit hollows; installation of gas supply pipelines; installation of work platforms for operation, utility systems, configuration of architectural appearance, etc.

Another embodiment of the invention claimed is the complex for land storage of natural gas, methane comprising a gas treatment unit, gas compression unit and gas storage unit having constant pressure that are successively arranged, the gas storage unit comprising one or several land gas adsorptive storage modules each of which is a high-pressure tank designed in the form of vertically arranged large-diameter metal gas pipes having the operating pressure of at least 3 MPa; however, upper and lower crowns of pipes are closed with spherical covers, and the lower parts of the pipes are closed liners for fixation of the main part cast into cast-in-situ concrete, and the tank is filled with microporous adsorbent to the extent not exceeding 97% of its internal volume, and said adsorbent accumulates at least 155 nm³ of natural gas per 1 m³ of adsorbent.

Due to this, improvement of feasibility, maintainability and simplicity of complex manufacturing are provided, considerable reduction of the natural gas adsorptive storage module manufacturing time due to use of industrially produced elements taken from standardized items in the tank design that already have detailed process and regulatory documentation developed, and an extensive experience of operation thereof.

As an example, a variant of establishment of a pipeline gas storage is provided with the gas adsorptive storage module made of tanks that represent vertically arranged main gas pipes with diameter of 1,420 mm designed for the pressure of 9.8 MPa as per GOST R 52079-2003; FIG. 6. Pipes with the height of approximately 31 meters are vertically installed on a reinforced concrete base (grillage), and the upper and the lower crowns of pipes are closed with spherical covers. The lower parts of pipes are closed liners for fixation of the main part cast into cast-in-situ concrete together with the foundation monolithic grillage.

For convenience of construction and maintenance, it would be feasible to divide the natural gas adsorptive storage module into two levels: the upper and the lower ones; FIG. 6-7. Approach to the gas supply pipeline system and other systems for servicing of which a special operational platform is provided for is made at the lower level. The upper level is a reinforced concrete flooring of cast-in-situ design part of the load of which is transferred to the pipes themselves. A rail-mounted gantry crane 31, as well as a high operational platform are mounted to service the module at the second level.

Prior to installation, pipes may already be filled with adsorbent effective for storage of natural gas. However, adsorbent placement in the form of molds in special-purpose briquets may also be carried out already after vertical positioning of the pipes using a crane.

Vertically positioned high-pressure pipe tanks are arranged in an array to make sure that the set volume of the natural gas adsorptive storage module is achieved. Optimality of this solution is ensured by the fact that the structure consists of industrially produced standardized items that already have detailed process and regulatory documentation developed for, and an extensive experience of operation thereof. In addition, it is always possible to perform fine tuning of the storage capacity by introduction or removal of new tanks; FIG. 6-7.

FIG. 6-7 show the sketches of the complex for land adsorptive storage of natural gas comprising vertical adsorptive pipe columns 27, bearing wall 28 of gas adsorptive storage module, module foundation slabs 29, gas supply pipelines 30 and crane 31 for maintenance of the adsorptive pipe columns. Pipes (1,420 mm main gas pipes) of the gas adsorptive storage module are arranged in parallel rows containing 51 pieces each.

This solution also provides a number of advantages for development of transportation and logistics strategy for delivery of cargoes and materials to the construction site. Currently, transportation process flow charts and rigging have already been developed for delivery of the main type of items (pipes) for production of the natural gas adsorptive storage modules' tanks.

The group of inventions provided ensures simplicity of implementation by using type elements and modular design of Complexes, improvement of energy efficiency during gas storage filling due to reduction of the complex filling pressure, increase in explosion safety during storage of natural gas with preservation of its quality and calorie content due to storage of gas in pressurized tanks that prevent contamination of gas and environment and that are filled with a special nanoporous adsorbent ensuring nanodispersion of natural gas in micropores (one pore includes 20-30 molecules). This prevents the gas from abrupt discharge in case of vessel depressurization due to gas diffusion in the micropores that possess elevated heat-absorption capacity which, in turn, facilitates explosion reaction inhibition. They also provide for the endothermal effect during gas output which results in material “cooldown” in case of gas discharge and in inhibition thereof. The group of inventions provided ensures the possibility of implementation of energy-saving filling and extraction of gas staged by pressure, reduction of specific metal quantity of the storage module, as well as improvement of feasibility and simplicity of the Complex manufacturing, essential reduction of the time for manufacture of the gas adsorptive storage module, reduction of natural gas storage costs due to cost improvement for the gas adsorptive storage module and due to use of modular structures based on application of type industrial solutions.

1. A complex for land adsorptive storage of natural gas, methane comprising:
a gas treatment unit,
a gas compression unit, and
a gas storage unit having constant pressure,
wherein the gas treatment unit, the gas compression unit, and the gas storage unit are successively arranged, the gas storage unit comprising one or several land gas adsorptive storage modules each of which is a high-pressure vertical cylindrical gas tank designed in the form of a set of concentrically arranged cylindrical shells with different diameter placed one inside another and having an annular gap there between filled with a microporous adsorbent to the extent not exceeding 97% of its volume, and said adsorbent accumulates at least 155 nm³ of natural gas per 1 m³ of adsorbent; wherein the thicknesses of all shells are equal and a gas storage pressure in the tank increases from the periphery towards the center.

2. A complex for land adsorptive storage of natural gas, methane comprising:
a gas treatment unit,
a gas compression unit, and
a gas storage unit having constant pressure,
wherein the gas treatment unit, the gas compression unit, and the gas storage unit are successively arranged, the gas storage unit comprising one or several land gas adsorptive storage modules each of which is a high-pressure tank the bearing wall of which is made of cast-in-situ reinforced concrete reinforced with pre-stressed rods, or has a combined design of a series of layers made of metal and cast-in-situ reinforced concrete reinforced with pre-stressed rods; wherein the inner surface of the tank is lined using a gas-barrier material, the tank is filled with a microporous adsorbent to the extent not exceeding 97% of its internal volume, and said adsorbent accumulates at least 155 nm³ of natural gas per 1 m³ of adsorbent.

3. A complex for land storage of natural gas, methane comprising:
a gas treatment unit,
a gas compression unit, and
a gas storage unit having constant pressure,
wherein the gas treatment unit, the gas compression unit, and the gas storage unit are successively arranged, the gas storage unit comprising one or several land gas adsorptive storage modules each of which is a high-pressure tank designed in the form of vertically arranged large-diameter metal gas pipes having the operating pressure of at least 3 MPa; wherein upper and lower crowns of pipes are closed with spherical covers, the lower parts of the pipes are closed liners for fixation of the main part cast into cast-in-situ concrete, and the tank is filled with microporous adsorbent to the extent not exceeding 97% of its internal volume, and said adsorbent accumulates at least 155 nm³ of natural gas per 1 m³ of adsorbent.

4. The complex according to claim 1, wherein the microporous adsorbent may be granulated or compacted in the form of blocks.

5. The complex according to claim 1, wherein gas treatment unit includes the sections for purification from solid inclusions and foreign admixtures, section of natural gas flow enrichment with methane and C2+ hydrocarbon storage section; gas storage unit additionally includes C2+ capturing and storage module the inner volume of which is filled with adsorbent having the ethane/methane separation coefficient of at least 2 and installed in front of the land gas adsorptive storage module, compensation tank to release pressure exceeding the operating pressure of the high-pressure tank, as well as the regeneration section of the land gas adsorptive storage module connected with the high-pressure tank and C2+ hydrocarbon capturing and storage module.

6. The complex according to claim 5, wherein the C2+ hydrocarbon capturing and storage module is granulated or compacted in the form of blocks.

7. The complex according to claim 1, wherein modules of the land gas adsorptive storage are mounted in such a way that each of them may be individually disconnected from the gas source.

8. A method for land adsorptive storage of natural gas, methane including:
offtake of natural gas from a gas source,
treatment of microporous adsorbent accumulating at least 155 nm³ of natural gas per 1 m³ of adsorbent in the high-pressure tank of the land gas adsorptive storage module of the gas storage unit,
further filling of the gas storage unit with gas directly from the gas source until the gas storage pressure of 3-10 MPa is achieved; or
offtake of natural gas from a gas source,
treatment of the offtake of natural gas in the natural gas treatment unit that includes purification from solid inclusions and foreign admixtures,
treatment of microporous adsorbent accumulating at least 155 nm³ of natural gas per 1 m³ of adsorbent in the high-pressure tank of the land gas adsorptive storage module of the gas storage unit,
further filling of the gas storage unit with purified gas until the gas storage pressure of 3-10 MPa or the gas source pressure is achieved, and then, through the natural gas compression unit, until the gas storage pressure of 3-10 MPa is achieved.

9. The method according to claim 8, wherein natural gas treatment includes natural gas separation using a cryogenic, adsorptive or membrane method or the combination thereof into methane-enriched natural gas and C2+ hydrocarbon concentrate.

10. The method according to claim 8, wherein treatment of microporous adsorbent in the granulated form or compacted in the form of blocks in high-pressure tanks is carried out by purging with heated nitrogen with excess pressure of up to 0.05 MPa, vacuuming until rarefaction of not more than 10-4 MPa is achieved and further purging with purified and methane-enriched natural gas at excess pressure of 0.05-0.15 MPa.

11. The method according to claim 8, wherein, in the gas storage unit, purified gas is fed to the C2+ hydrocarbon capturing and storage module the inner volume of which is filled with adsorbent having the ethane/methane separation coefficient of at least 2, and then the methane-enriched gas is delivered for storage to the land gas adsorptive storage module.

12. The method according to claim 11, wherein purified gas is fed to the C2+ hydrocarbon capturing and storage module the inner volume of which is filled with adsorbent in the granulated form or compacted in the form of blocks.
